(19) United States
(12) Patent Application Publication
(10) Pub. No.: US 2026/0049827 A1
(43) Pub. Date: Feb. 19, 2026

(54) NAVIGATION SYSTEM, NAVIGATION METHOD, AND NON-TRANSITORY RECORDING MEDIUM

(71) Applicant: Toyota Jidosha Kabushiki Kaisha, Toyota-shi (JP)

(72) Inventor: Daisuke HASHIMOTO, Chofu-shi (JP)

(73) Assignee: Toyota Jidosha Kabushiki Kaisha, Toyota-shi (JP)

(21) Appl. No.: 19/245,707

(22) Filed: Jun. 23, 2025

(30) Foreign Application Priority Data
Aug. 15, 2024 (JP) 2024-135746

(51) Int. Cl. G01C 21/34; G01C 21/36; G06V 20/59

(52) U.S. Cl. CPC G01C 21/3484; G01C 21/3629; G06V 20/597

(57) ABSTRACT

A navigation system generates navigation information used for providing navigation to a driver of a vehicle based on current position of the vehicle, map information, and destination information indicating a destination of the vehicle, generates transmission information which is information to be communicated to the driver via a user interface based on the navigation information, and determines whether there has been confusion in any of recognition, decision, and operation of the driver with respect to the transmission information communicated from the user interface to the driver based on reaction of the driver to the transmission information. The transmission information or the navigation information is generated so that the confusion is suppressed based on the transmission information communicated to the driver via the user interface and the reaction of the driver to the transmission information when it is determined that there has been the confusion.

### FIELD

The present disclosure relates to a navigation system, a navigation method, and a non-transitory recording medium.

### BACKGROUND

PTL 1 (JP 2024-20616 A) describes that a parameter of a navigation command related to steering is adjusted in consideration of a degree of difficulty with steering, a machine learning model generates a metric of the degree of difficulty with a set of steering, and query data is applied to the machine learning model in order to generate the metric of the degree of difficulty with steering.

PTL 1 describes a factor of confusion, but does not describe a technique for suppressing confusion of a driver. Thus, the technique described in PTL 1 (technique for generating the metric of the degree of difficulty) cannot suppress a risk that a driver of a vehicle gets confused when navigation is provided to the driver.

### SUMMARY

In view of the points described above, it is an object of the present disclosure to provide a navigation system, a navigation method, and a non-transitory recording medium which can suppress a risk that a driver of a vehicle gets confused when navigation is provided to the driver.

(1) One aspect of the present disclosure is a navigation system including a processor configured to: generate navigation information used for providing navigation to a driver of a vehicle based on current position of the vehicle, map information, and destination information indicating a destination of the vehicle; generate transmission information which is information to be communicated to the driver via a user interface based on the navigation information; and determine whether there has been confusion in any of recognition, decision, and operation of the driver with respect to the transmission information communicated from the user interface to the driver based on reaction of the driver to the transmission information, wherein the transmission information is generated or the navigation information is generated so that the confusion in any of the recognition, the decision, and the operation of the driver is suppressed based on the transmission information communicated to the driver via the user interface and the reaction of the driver to the transmission information when it is determined that there has been the confusion in any of the recognition, the decision, and the operation of the driver with respect to the transmission information.

(2) In the navigation system of the aspect (1), a first machine learning model stored in a storage device of the vehicle and a second machine learning model stored in a storage device of a server may be included in the navigation system, the second machine learning model may generate an advance instruction to the first machine learning model based on the destination information, and the first machine learning model may generate the transmission information in real time based on the advance instruction generated by the second machine learning model and the navigation information.

(3) In the navigation system of the aspect (1) or (2), the processor may be configured to generate the transmission information or generate the navigation information so that the confusion in any of the recognition, the decision, and the operation of the driver is suppressed based on personal information related to any of the recognition, the decision, and the operation of the driver, the transmission information, and the reaction of the driver to the transmission information.

(4) The navigation system of any of the aspects (1) to (3) may include a simulator disposed in the server, wherein the simulator may simulate behavior to generate the navigation information, and the second machine learning model may cooperate with the simulator, and repeatedly perform prediction of behavior of the driver and optimization of the transmission information.

(5) In the navigation system of any of the aspects (1) to (4), the transmission information may be communicated from the user interface to the driver as voice guidance output from a speaker or image guidance displayed on a display.

(6) In the navigation system of any of the aspects (1) to (5), determination of whether there has been the confusion in any of the recognition, the decision, and the operation of the driver with respect to the transmission information may be performed by a recognizer which detects information of a compartment line included in an image captured by a front camera mounted on the vehicle.

(7) In the navigation system of any of the aspects (1) to (6), determination of whether there has been the confusion in any of the recognition, the decision, and the operation of the driver with respect to the transmission information may be performed by the processor which controls braking actuator or steering actuator based on the operation of the driver.

(8) In the navigation system of any of the aspects (1) to (7), determination of whether there has been the confusion in any of the recognition, the decision, and the operation of the driver with respect to the transmission information may be performed by a driver monitoring system for identifying the reaction of the driver to the transmission information based on image of the driver captured by a driver monitor camera or voice of the driver collected by a microphone.

(9) In the navigation system of any of the aspects (1) to (8), the transmission information generated by the processor may include information of any of timing, order, granularity and concreteness of guidance, additional information provided during guidance, type, tone, volume and speaking style of voice, display content, display position, display size, color and font of the image guidance.

(10) In the navigation system of any of the aspects (1) to (9), the processor may be configured to perform addition or update of the transmission information based on the reaction of the driver to the transmission information communicated from the user interface to the driver.

(11) One aspect of the present disclosure is a navigation method including: generating navigation information used for providing navigation to a driver of a vehicle based on current position of the vehicle, map information, and destination information indicating a destination of the vehicle; generating transmission information which is information to be communicated to the driver via a user interface based on the navigation information; and determining whether there has been confusion in any of recognition, decision, and operation of the driver with respect to the transmission information communicated from the user interface to the driver based on reaction of the driver to the transmission information, wherein the transmission information is generated or the navigation information is generated so that the confusion in any of the recognition, the decision, and the operation of the driver is suppressed based on the transmission information communicated to the driver via the user interface and the reaction of the driver to the transmission information when it is determined that there has been the confusion in any of the recognition, the decision, and the operation of the driver with respect to the transmission information.

(12) One aspect of the present disclosure is a non-transitory recording medium having recorded thereon a computer program for causing a processor included in a computer mounted on a vehicle to perform a process including: generating navigation information used for providing navigation to a driver of a vehicle based on current position of the vehicle, map information, and destination information indicating a destination of the vehicle; generating transmission information which is information to be communicated to the driver via a user interface based on the navigation information; and determining whether there has been confusion in any of recognition, decision, and operation of the driver with respect to the transmission information communicated from the user interface to the driver based on reaction of the driver to the transmission information, wherein the transmission information is generated or the navigation information is generated so that the confusion in any of the recognition, the decision, and the operation of the driver is suppressed based on the transmission information communicated to the driver via the user interface and the reaction of the driver to the transmission information when it is determined that there has been the confusion in any of the recognition, the decision, and the operation of the driver with respect to the transmission information.

According to the present disclosure, a risk that a driver of a vehicle gets confused when navigation is provided to the driver can be suppressed.

### BRIEF DESCRIPTION OF DRAWINGS

FIG. 1 is a view showing one example of a navigation system SY of a first embodiment.

FIG. 2 is a view showing one example of a vehicle VH, a server SV, and the like to which the navigation system SY shown in FIG. 1 is applied.

FIG. 3 is a view showing one example of a configuration of the vehicle VH shown in FIG. 2.

FIG. 4 is a view showing one example of a configuration of the server SV shown in FIG. 2.

FIG. 5 is a view for explaining a first example of navigation information (travel route plan of the vehicle VH) generated by a navigation information generation unit SY1.

FIG. 6 is a view for explaining a second example of the navigation information (travel route plan of the vehicle VH) generated by the navigation information generation unit SY1.

FIG. 7 is a view for explaining a third example of the navigation information (travel route plan of the vehicle VH) generated by the navigation information generation unit SY1.

FIG. 8 is a view for explaining a fourth example of the navigation information (travel route plan of the vehicle VH) generated by the navigation information generation unit SY1.

FIG. 9 is a view for explaining a fifth example of the navigation information (travel route plan of the vehicle VH) generated by the navigation information generation unit SY1.

FIG. 10 is a flowchart for explaining one example of process performed by a processor VH73 of a computer VH7 mounted on the vehicle VH to which the navigation system SY of a second embodiment is applied.

### DESCRIPTION OF EMBODIMENTS

Embodiments of a navigation system, a navigation method, and a non-transitory recording medium of the present disclosure will be described below with reference to the drawings.

### First Embodiment

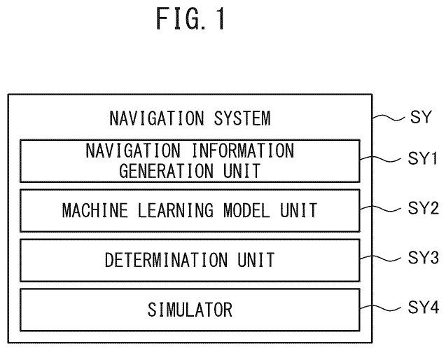

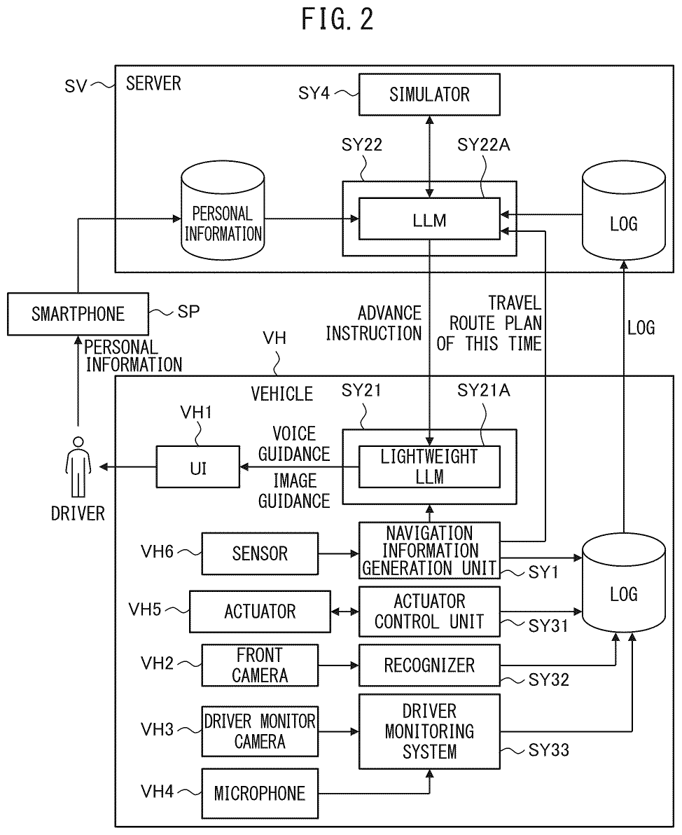

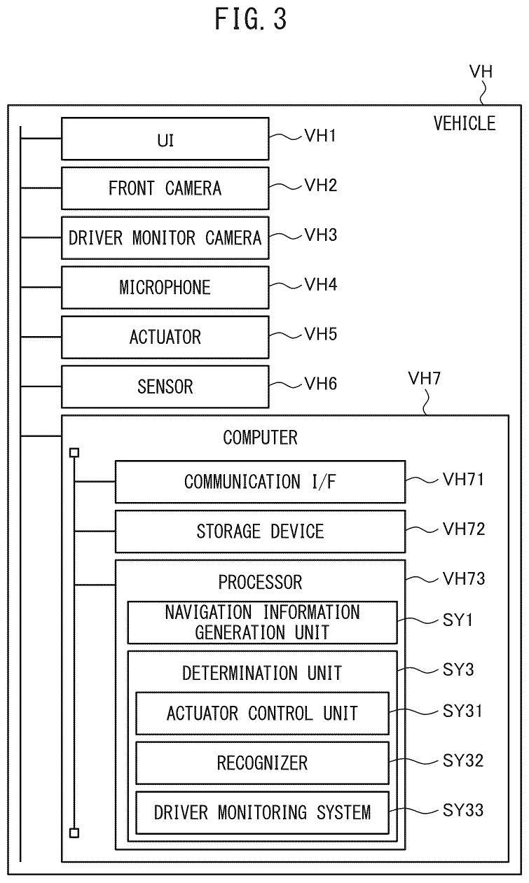

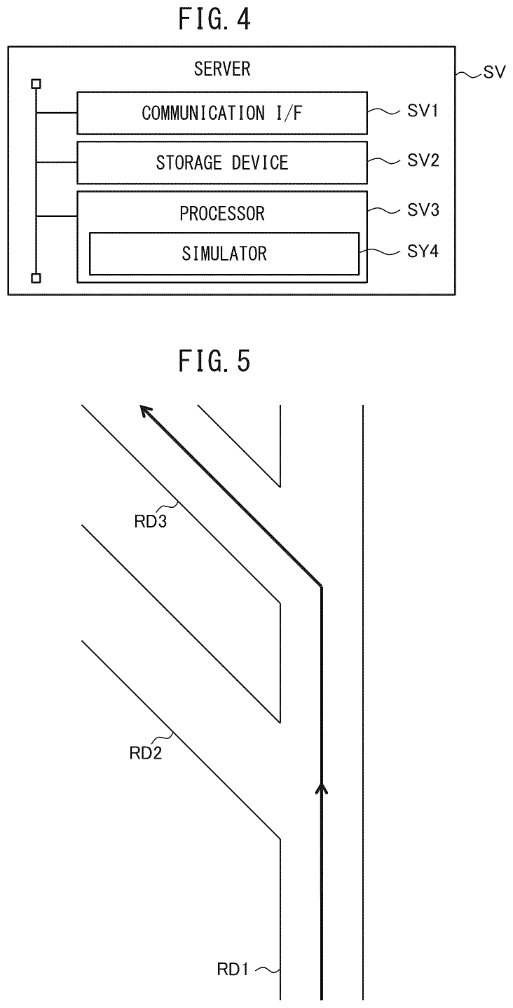

FIG. 1 is a view showing one example of a navigation system SY of a first embodiment. FIG. 2 is a view showing one example of a vehicle VH, a server SV, and the like to which the navigation system SY shown in FIG. 1 is applied. FIG. 3 is a view showing one example of a configuration of the vehicle VH shown in FIG. 2. FIG. 4 is a view showing one example of a configuration of the server SV shown in FIG. 2.

In the example shown in FIG. 1 to FIG. 4, the navigation system SY is configured by a computer VH7 mounted on the vehicle VH and including a communication interface VH71, a storage device VH72, and a processor VH73, and a computer of the server SV including a communication interface SV1, a storage device SV2, and a processor SV3. The navigation system SY includes a navigation information generation unit SY1, a machine learning model unit SY2, a determination unit SY3, and a simulator SY4.

The processor VH73 of the computer VH7 of the vehicle VH has a function as the navigation information generation unit SY1. The navigation information generation unit SY1 generates navigation information used for providing navigation to a driver of the vehicle VH based on current position of the vehicle VH, map information, and destination information indicating a destination of the vehicle VH. The current position of the vehicle VH is calculated by, for example, the navigation information generation unit SY1 based on a global positioning system (GPS) signal received by a GPS receiver functioning as, for example, a sensor VH6. The map information is stored in, for example, the storage device VH72 of the computer VH7.

In another example, the map information may be acquired from the outside of the vehicle VH by the communication interface VH71 of the computer VH7.

In the example shown in FIG. 1 to FIG. 4, the destination information indicating the destination of the vehicle VH is input by the driver of the vehicle VH via, for example, a user interface (UI) VH1 of the vehicle VH.

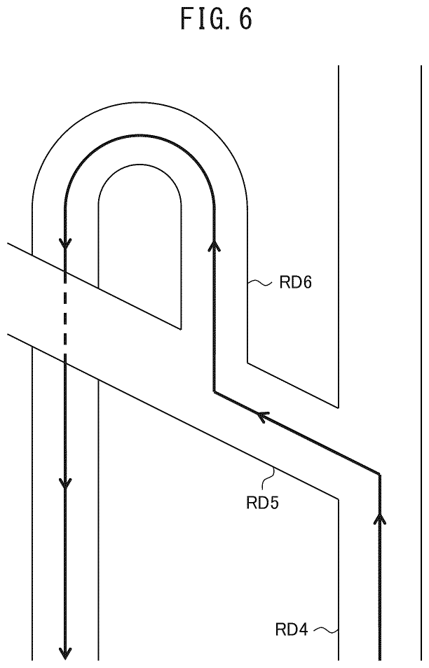

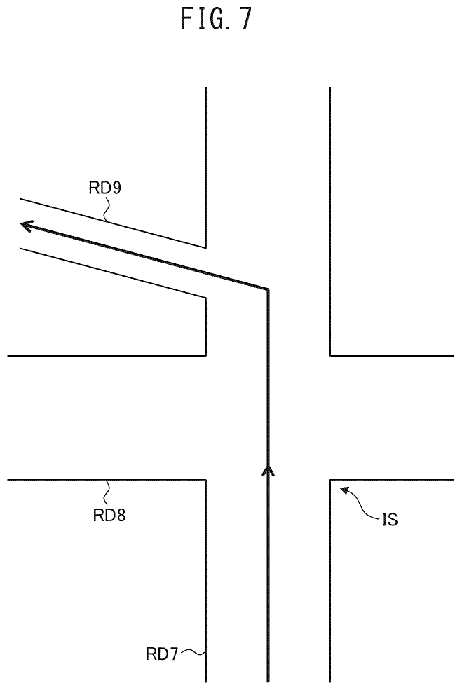

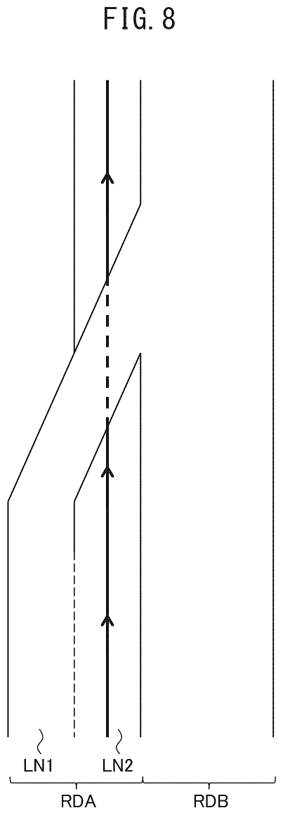

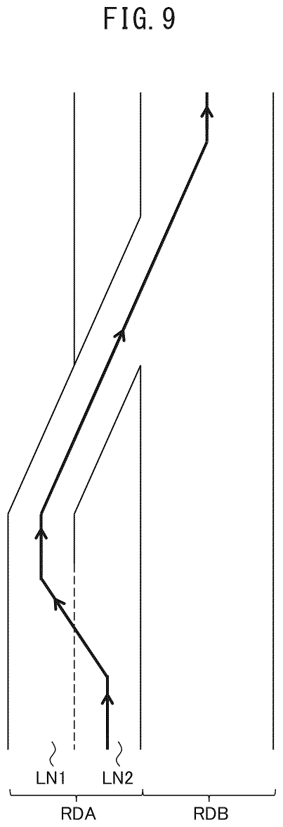

FIG. 5 is a view for explaining a first example of the navigation information (travel route plan of the vehicle VH) generated by the navigation information generation unit SY1. FIG. 6 is a view for explaining a second example of the navigation information (travel route plan of the vehicle VH) generated by the navigation information generation unit SY1. FIG. 7 is a view for explaining a third example of the navigation information (travel route plan of the vehicle VH) generated by the navigation information generation unit SY1. FIG. 8 is a view for explaining a fourth example of the navigation information (travel route plan of the vehicle VH) generated by the navigation information generation unit SY1. FIG. 9 is a view for explaining a fifth example of the navigation information (travel route plan of the vehicle VH) generated by the navigation information generation unit SY1.

In the example shown in FIG. 5, the navigation information generation unit SY1 generates the travel route plan of the vehicle VH indicated by an arrow in FIG. 5 as the travel route plan (navigation information) of the vehicle VH from the current position of the vehicle VH to the destination of the vehicle VH. In order to travel from the current position of the vehicle VH to the destination of the vehicle VH, the vehicle VH needs to go straight down a road RD1 at a junction with a road RD2 without turning left on the road RD1 at the junction with the road RD2, and turn left on the road RD1 at a junction with a road RD3 immediately after going straight down the road RD1 at the junction with the road RD2.

If the transmission information of “turn left after 400 m” is generated as the transmission information which is information to be communicated to the driver of the vehicle VH based on the travel route plan (navigation information) of the vehicle VH indicated by the arrow in FIG. 5, the driver of the vehicle VH may not be able to accurately grasp “after 400 m” and the vehicle VH may not be able to appropriately turn left on the road RD1 at the junction with the road RD3 (for example, the vehicle VH may turn left on the road RD1 at the junction with the road RD2, the vehicle VH may go straight down the road RD1 at the junction with the road RD3, or the like), depending on the shape of the roads RD1, RD2, and RD3, the cognitive ability of the driver of the vehicle VH, the tension of the driver of the vehicle VH, and the like.

Further, if the transmission information of “turn left at the second junction” is generated as the transmission information which is the information to be communicated to the driver of the vehicle VH based on the travel route plan (navigation information) of the vehicle VH indicated by the arrow in FIG. 5, the driver of the vehicle VH may not be able to accurately recognize “the second junction” and the vehicle VH may not be able to appropriately turn left on the road RD1 at the junction with the road RD3 (for example, the vehicle VH may turn left on the road RD1 at the junction with the road RD2, the vehicle VH may go straight down the road RD1 at the junction with the road RD3, or the like), depending on the shape of the roads RD1, RD2, and RD3, the cognitive ability of the driver of the vehicle VH, the tension of the driver of the vehicle VH, the spatial cognitive ability of the driver of the vehicle VH, and the like.

Thus, in the navigation system SY of the first embodiment, the process described below is performed in the machine learning model unit SY2 and the like so that the vehicle VH can appropriately turn left on the road RD1 at the junction with the road RD3 regardless of the shape of the roads RD1, RD2, and RD3, the cognitive ability of the driver of the vehicle VH, the tension of the driver of the vehicle VH, and the like.

In the example shown in FIG. 6, the navigation information generation unit SY1 generates the travel route plan of the vehicle VH indicated by an arrow in FIG. 6 as the travel route plan (navigation information) of the vehicle VH from the current position of the vehicle VH to the destination of the vehicle VH. In order to travel from the current position of the vehicle VH to the destination of the vehicle VH, the vehicle VH needs to turn right on a road RD5 at a junction with a road RD6 immediately after turning left on a road RD4 at a junction with the road RD5.

If the transmission information of “turn left after 300 m” is generated as the transmission information which is the information to be communicated to the driver of the vehicle VH, and the transmission information of “turn right after 50 m” is generated as the transmission information immediately after the vehicle VH turns left on the road RD4 at the junction with the road RD5 based on the travel route plan (navigation information) of the vehicle VH indicated by the arrow in FIG. 6, the driver of the vehicle VH is required to perform a cognitive decision operation in succession, and thus the driver of the vehicle VH may get confused and make a wrong decision (for example, the vehicle VH may go straight down the road RD5 without turning right on the road RD5 at the junction with the road RD6, or the like). Alternatively, presentation of the transmission information of “turn right after 50 m” to the driver of the vehicle VH may be late due to process delay, communication delay, and the like, and the vehicle VH may not be able to turn right on the road RD5 at the junction with the road RD6.

Further, if the transmission information of “Turn left after 300 m. Then, turn right after 70 m.” is generated as the transmission information which is the information to be communicated to the driver of the vehicle VH based on the travel route plan (navigation information) of the vehicle VH indicated by the arrow in FIG. 6, the driver of the vehicle VH is required to perform a cognitive decision operation in succession, and thus it may put a burden on the cognitive decision operation of the driver of the vehicle VH when the vehicle VH turns left on the road RD4 at the junction with the road RD5, and the driver of the vehicle VH may forget that the vehicle VH needs to turn right on the road RD5 at the junction with the road RD6.

Thus, in the navigation system SY of the first embodiment, the process described below is performed in the machine learning model unit SY2 and the like so that the vehicle VH can appropriately turn left on the road RD4 at the junction with the road RD5 and appropriately turn right on the road RD5 at the junction with the road RD6 regardless of the shape of the roads RD4, RD5, and RD6, the cognitive ability of the driver of the vehicle VH, the tension of the driver of the vehicle VH, and the like.

In the example shown in FIG. 7, the navigation information generation unit SY1 generates the travel route plan of the vehicle VH indicated by an arrow in FIG. 7 as the travel route plan (navigation information) of the vehicle VH from the current position of the vehicle VH to the destination of the vehicle VH. In order to travel from the current position of the vehicle VH to the destination of the vehicle VH, the vehicle VH needs to turn left on a road RD7 at a junction with a small road RD9 immediately after going straight down the road RD7 at a junction with a large road RD8 (immediately after passing through an intersection IS).

When inappropriate transmission information is generated as the transmission information which is the information to be communicated to the driver of the vehicle VH and the driver of the vehicle VH cannot afford to look at image guidance displayed on a display, the driver of the vehicle VH may make a wrong decision (for example, the vehicle VH may turn left on the road RD7 at the junction with the road RD8, or the like).

Thus, in the navigation system SY of the first embodiment, the process described below is performed in the machine learning model unit SY2 and the like so that the vehicle VH can appropriately go straight down the road RD7 at the junction with the road RD8 and appropriately turn left on the road RD7 at the junction with the road RD9 regardless of the shape of the roads RD7, RD8, and RD9, the cognitive ability of the driver of the vehicle VH, the tension of the driver of the vehicle VH, and the like.

In the example shown in FIG. 8, the navigation information generation unit SY1 generates the travel route plan of the vehicle VH indicated by an arrow in FIG. 8 as the travel route plan (navigation information) of the vehicle VH from the current position of the vehicle VH to the destination of the vehicle VH. In order to travel from the current position to the vehicle VH to the destination of the vehicle VH, the vehicle VH needs to continue traveling on an ordinary road RDA without entering an expressway RDB from the ordinary road RDA.

In general, when a vehicle enters the expressway from the ordinary road, the vehicle often travels on a right lane among a left lane and the right lane of the ordinary road and enters the expressway.

In the example shown in FIG. 8 in which the ordinary road RDA and the expressway RDB are configured so that the vehicle VH travels on the left lane LN1 among the left lane LN1 and the right lane LN2 of the ordinary road RDA and enters the expressway RDB, the driver of the vehicle VH may misunderstand that the vehicle VH can continue to travel on the ordinary road RDA if the vehicle VH travels on the left lane LN1 of the ordinary road RDA, and the vehicle VH may enter the expressway RDB by mistake.

Thus, in the navigation system SY of the first embodiment, the process described below is performed in the machine learning model unit SY2 and the like so that the vehicle VH can continue to travel on the ordinary road RDA regardless of the shape of the left lane LN1 and the right lane LN2 of the ordinary road RDA, the shape of the expressway RDB, the cognitive ability of the driver of the vehicle VH, the tension of the driver of the vehicle VH, and the like.

In the example shown in FIG. 9, the navigation information generation unit SY1 generates the travel route plan of the vehicle VH indicated by an arrow in FIG. 9 as the travel route plan (navigation information) of the vehicle VH from the current position of the vehicle VH to the destination of the vehicle VH. In order to travel from the current position to the vehicle VH to the destination of the vehicle VH, the vehicle VH needs to enter the expressway RDB from the ordinary road RDA.

As described above, in general, when the vehicle enters the expressway from the ordinary road, the vehicle often travels on the right lane among the left lane and the right lane of the ordinary road and enters the expressway.

In the example shown in FIG. 9 in which the ordinary road RDA and the expressway RDB are configured so that the vehicle VH travels on the left lane LN1 among the left lane LN1 and the right lane LN2 of the ordinary road RDA and enters the expressway RDB, if the transmission information of “You will enter the expressway after 60 m.” is generated as the transmission information which is the information to be communicated to the driver of the vehicle VH based on the travel route plan (navigation information) of the vehicle VH indicated by the arrow in FIG. 9, the driver of the vehicle VH may misunderstand that the vehicle VH needs to travel on the right lane LN2 of the ordinary road RDA in order to enter the expressway RDB from the ordinary road RDA, and the vehicle VH may continue to travel on the ordinary road RDA by mistake (the vehicle VH may not be able to enter the expressway RDB).

Thus, in the navigation system SY of the first embodiment, the process described below is performed in the machine learning model unit SY2 and the like so that the vehicle VH can enter the expressway RDB from the ordinary road RDA regardless of the shape of the left lane LN1 and the right lane LN2 of the ordinary road RDA, the shape of the expressway RDB, the cognitive ability of the driver of the vehicle VH, the tension of the driver of the vehicle VH, and the like.

In the example shown in FIG. 1 to FIG. 4, the navigation information generation unit SY1 stores the generated navigation information as a log of an instruction issued from the navigation system SY to the driver of the vehicle VH, in the storage device VH72. Further, the navigation information generation unit SY1 transmits the generated navigation information as the travel route plan of the vehicle VH to the server SV via the communication interface VH71 of the computer VH7. Furthermore, the navigation information generation unit SY1 transmits the generated navigation information to the machine learning model unit SY2.

The machine learning model unit SY2 generates the transmission information which is the information to be communicated to the driver of the vehicle VH via the user interface VH1 based on the navigation information generated by the navigation information generation unit SY1.

In the example shown in FIG. 1 to FIG. 4, a first machine learning model SY21 (see FIG. 2) stored in the storage device VH72 of the computer VH7 of the vehicle VH and a second machine learning model SY22 (see FIG. 2) stored in the storage device SV2 of the server SV are included in the machine learning model unit SY2. The second machine learning model SY22 includes a large-scale language model (LLM) SY22A (see FIG. 2), and the first machine learning model SY21 includes a lightweight large-scale language model SY21A (see FIG. 2) which is lighter than the large-scale language model SY22A. The lightweight large-scale language model SY21A should be lighter than the large-scale language model SY22A, and may be a so-called small language model.

The second machine learning model SY22 generates an advance instruction to the first machine learning model SY21 based on, for example, the destination information input by the driver of the vehicle VH via the user interface VH1 of the vehicle VH, and personal information of the driver of the vehicle VH (characteristic of the driver of the vehicle VH) input in advance by the driver of the vehicle VH via a smartphone SP used by the driver of the vehicle VH (in the example shown in FIG. 2, the personal information of the driver of the vehicle VH is held in the server SV). Specifically, the second machine learning model SY22 generates the advance instruction to the first machine learning model SY21 when the destination information is input by the driver of the vehicle VH (i.e., before navigation is performed to the driver of the vehicle VH which is traveling). Further, the second machine learning model SY22 transmits the generated advance instruction to the first machine learning model SY21.

In another example, the personal information of the driver of the vehicle VH may be input in advance via the user interface VH1.

In the example shown in FIG. 1 to FIG. 4, the first machine learning model SY21 generates the transmission information which is the information to be communicated to the driver of the vehicle VH in real time (i.e., during traveling of the vehicle VH) based on the advance instruction generated by the second machine learning model SY22 and the navigation information generated by the navigation information generation unit SY1. In other words, the transmission information which is the information to be communicated to the driver of the vehicle VH is not generated by the second machine learning model SY22 of the server SV but generated by the first machine learning model SY21 of the vehicle VH. Thus, the transmission information can be generated in real time without an influence of the communication delay between the vehicle VH and the server SV. The first machine learning model SY21 transmits the generated transmission information as voice guidance output from a speaker (a part of the user interface VH1) or image guidance displayed on the display (another part of the user interface VH1) to the user interface VH1.

The user interface VH1 presents the transmission information (the voice guidance and the image guidance) generated by the first machine learning model SY21 to the driver of the vehicle VH. In other words, the transmission information generated by the machine learning model unit SY2 is communicated as the voice guidance or the image guidance from the user interface VH1 to the driver of the vehicle VH.

The transmission information generated by the machine learning model unit SY2 includes information of any of timing, order, granularity, and concreteness of guidance, additional information provided during guidance, type, tone, volume and speaking style of voice, display content, display position, display size, color and font of the image guidance.

In the example shown in FIG. 1 to FIG. 4, reaction of the driver of the vehicle VH to the transmission information communicated from the user interface VH1 to the driver of the vehicle VH is used so that the driver of the vehicle VH can cause the vehicle VH to appropriately travel based on the transmission information generated by the machine learning model unit SY2, regardless of the shape of the road on which the vehicle VH travels, the cognitive ability of the driver of the vehicle VH, the tension of the driver of the vehicle VH, and the like.

Specifically, in the example shown in FIG. 1 to FIG. 4, the processor VH73 of the computer VH7 of the vehicle VH has a function as the determination unit SY3. The determination unit SY3 determines whether there has been confusion in any of recognition, decision, and operation of the driver of the vehicle VH with respect to the transmission information communicated from the user interface VH1 to the driver of the vehicle VH based on the reaction of the driver of the vehicle VH to the transmission information.

The machine learning model unit SY2 generates the transmission information so that the confusion in any of the recognition, the decision, and the operation of the driver of the vehicle VH is suppressed based on the transmission information communicated to the driver of the vehicle VH via the user interface VH1 and the reaction of the driver of the vehicle VH to the transmission information when the determination unit SY3 determines that there has been the confusion in any of the recognition, the decision, and the operation of the driver of the vehicle VH with respect to the transmission information.

Specifically, the machine learning model unit SY2 generates the transmission information so that the confusion in any of the recognition, the decision, and the operation of the driver of the vehicle VH is suppressed based on the personal information related to any of the recognition, the decision, and the operation of the driver of the vehicle VH, the transmission information generated by the machine learning model unit SY2, and the reaction of the driver of the vehicle VH to the transmission information.

In the example shown in FIG. 2, the personal information related to any of the recognition, the decision, and the operation of the driver of the vehicle VH is input to the smartphone SP used by the driver of the vehicle VH, the smartphone SP transmits the personal information to the server SV, and the personal information is used in the second machine learning model SY22 of the machine learning model unit SY2.

In another example, the personal information related to any of the recognition, the decision, and the operation of the driver of the vehicle VH may be input to things other than the smartphone SP such as, for example, the user interface VH1, and communicated from things other than the smartphone SP to the server SV.

In the example shown in FIG. 1 to FIG. 4, an actuator control unit SY31 which controls an actuator VH5 (for example, a braking actuator, a steering actuator, a hazard lamp, and the like) based on the operation of the driver of the vehicle VH, is included in the determination unit SY3.

Specifically, if a brake pedal is unnecessarily pressed down (i.e., the braking actuator is controlled) when the operation of the driver of the vehicle VH of causing the vehicle VH to turn right or turn left is needed, the determination unit SY3 (actuator control unit SY31) determines that there has been the confusion in any of the recognition, the decision, and the operation of the driver of the vehicle VH with respect to the transmission information.

Further, if the steering wheel operation wobbles left and right (i.e., unnecessary control of the steering actuator is performed) when the operation of the driver of the vehicle VH of causing the vehicle VH to turn right or turn left is needed, the determination unit SY3 (actuator control unit SY31) determines that there has been the confusion (indecision) in any of the recognition, the decision, and the operation of the driver of the vehicle VH with respect to the transmission information.

Furthermore, if the driver of the vehicle VH turns on the hazard lamp which is unnecessary for the vehicle VH to turn right or turn left when the operation of the driver of the vehicle VH of causing the vehicle VH to turn right or turn left is needed, the determination unit SY3 (actuator control unit SY31) determines that there has been the confusion in any of the recognition, the decision, and the operation of the driver of the vehicle VH with respect to the transmission information.

The actuator control unit SY31 transmits the log of the operation of the driver of the vehicle VH when the actuator control unit SY31 determines that there has been the confusion (indecision) in any of the recognition, the decision, and the operation of the driver of the vehicle VH with respect to the transmission information, to the second machine learning model SY22 of the server SV. When the actuator control unit SY31 determines that there has been the confusion (indecision) in any of the recognition, the decision, and the operation of the driver of the vehicle VH with respect to the transmission information, the log of the instruction issued from the navigation system SY to the driver of the vehicle VH (navigation information generated by the navigation information generation unit SY1) is also communicated to the second machine learning model SY22 of the server SV.

the machine learning model unit SY2 generates the transmission information so that the confusion in any of the recognition, the decision, and the operation of the driver of the vehicle VH is suppressed based on the transmission information communicated to the driver of the vehicle VH via the user interface VH1 when the actuator control unit SY31 determines that there has been the confusion (indecision) in any of the recognition, the decision, and the operation of the driver of the vehicle VH with respect to the transmission information, and the reaction of the driver of the vehicle VH to the transmission information (operation of the driver of the vehicle VH).

In the example shown in FIG. 1 to FIG. 4, a recognizer SY32 which detects information such as a compartment line included in an image captured by a front camera VH2 mounted on the vehicle VH is included in the determination unit SY3. The compartment line is an indication provided on a road when a flow of traffic needs to be appropriately directed, and includes, for example, a guidance zone (zebra zone).

Specifically, if the recognizer SY32 detects that the vehicle VH unnecessarily enters the zebra zone when the operation of the driver of the vehicle VH of causing the vehicle VH to turn right or turn left is needed, the determination unit SY3 determines that there has been the confusion in any of the recognition, the decision, and the operation of the driver of the vehicle VH with respect to the transmission information.

Further, if the recognizer SY32 detects that the vehicle VH unnecessarily enters a road shoulder when the operation of the driver of the vehicle VH of causing the vehicle VH to turn right or turn left is needed, the determination unit SY3 determines that there has been the confusion in any of the recognition, the decision, and the operation of the driver of the vehicle VH with respect to the transmission information.

Furthermore, if the recognizer SY32 detects that the vehicle VH unnecessarily crosses the compartment line when the operation of the driver of the vehicle VH of causing the vehicle VH to turn right or turn left is needed, the determination unit SY3 determines that there has been the confusion in any of the recognition, the decision, and the operation of the driver of the vehicle VH with respect to the transmission information.

Further, if the recognizer SY32 detects that the vehicle VH travels against the laws and regulations (for example, the vehicle VH travels in an opposite direction) when the operation of the driver of the vehicle VH of causing the vehicle VH to turn right or turn left is needed, the determination unit SY3 determines that there has been the confusion in any of the recognition, the decision, and the operation of the driver of the vehicle VH with respect to the transmission information.

The recognizer SY32 transmits the log of the operation of the driver of the vehicle VH when the recognizer SY32 determines that there has been the confusion in any of the recognition, the decision, and the operation of the driver of the vehicle VH with respect to the transmission information, to the second machine learning model SY22 of the server SV. When the recognizer SY32 determines that there has been the confusion in any of the recognition, the decision, and the operation of the driver of the vehicle VH with respect to the transmission information, the log of the instruction issued from the navigation system SY to the driver of the vehicle VH (navigation information generated by the navigation information generation unit SY1) is also communicated to the second machine learning model SY22 of the server SV.

The machine learning model unit SY2 generates the transmission information so that the confusion in any of the recognition, the decision, and the operation of the driver of the vehicle VH is suppressed based on the transmission information communicated to the driver of the vehicle VH via the user interface VH1 when the recognizer SY32 determines that there has been the confusion in any of the recognition, the decision, and the operation of the driver of the vehicle VH with respect to the transmission information, and the reaction of the driver of the vehicle VH to the transmission information (operation of the vehicle VH by the driver of the vehicle VH).

Furthermore, in the example shown in FIG. 1 to FIG. 4, a driver monitoring system SY33 for identifying the reaction of the driver of the vehicle VH to the transmission information generated by the machine learning model unit SY2 is included in the determination unit SY3.

The driver monitoring system SY33 identifies the reaction of the driver of the vehicle VH to the transmission information generated by the machine learning model unit SY2 (i.e., determines whether there has been the confusion in any of the recognition, the decision, and the operation of the driver of the vehicle VH with respect to the transmission information) based on an image of the driver of the vehicle VH captured by a driver monitor camera VH3 mounted on the vehicle VH.

The driver monitoring system SY33 identifies the reaction of the driver of the vehicle VH to the transmission information generated by the machine learning model unit SY2 (i.e., determines whether there has been the confusion in any of the recognition, the decision, and the operation of the driver of the vehicle VH with respect to the transmission information) based on voice of the driver of the vehicle VH collected by a microphone VH4 mounted on the vehicle VH.

The driver monitoring system SY33 transmits the log of the operation of the driver of the vehicle VH when the driver monitoring system SY33 determines that there has been the confusion in any of the recognition, the decision, and the operation of the driver of the vehicle VH with respect to the transmission information, to the second machine learning model SY22 of the server SV. When the driver monitoring system SY33 determines that there has been the confusion in any of the recognition, the decision, and the operation of the driver of the vehicle VH with respect to the transmission information, the log of the instruction issued from the navigation system SY to the driver of the vehicle VH (navigation information generated by the navigation information generation unit SY1) is also communicated to the second machine learning model SY22 of the server SV.

The machine learning model unit SY2 generates the transmission information so that the confusion in any of the recognition, the decision, and the operation of the driver of the vehicle VH is suppressed based on the transmission information communicated to the driver of the vehicle VH via the user interface VH1 when the driver monitoring system SY33 determines that there has been the confusion in any of the recognition, the decision, and the operation of the driver of the vehicle VH with respect to the transmission information, and the reaction of the driver of the vehicle VH to the transmission information.

In the example shown in FIG. 2, the log of the operation (log of a wrong operation) of the driver of the vehicle VH when it is determined that there has been the confusion (indecision) in any of the recognition, the decision, and the operation of the driver of the vehicle VH with respect to the transmission information is held in both of the vehicle VH and the server SV.

For example, the log of the operation of the driver of the vehicle VH when the vehicle VH moves along a route which is different from a route instructed by the navigation system SY corresponds to the log of the wrong operation.

For example, the log of the operation of the driver of the vehicle VH of unnecessarily pressing down the brake pedal when the operation of the driver of the vehicle VH of causing the vehicle VH to turn right or turn left is needed corresponds to the log of the wrong operation.

For example, the log of the operation of the driver of the vehicle VH in a case in which the steering wheel operation wobbles left and right (there is indecision in the operation) when the operation of the driver of the vehicle VH of causing the vehicle VH to turn right or turn left is needed corresponds to the log of the wrong operation.

For example, the log of the operation of the driver of the vehicle VH of causing the vehicle VH to unnecessarily cross the compartment line when the operation of the driver of the vehicle VH of causing the vehicle VH to turn right or turn left is needed corresponds to the log of the wrong operation.

For example, the log of the operation of the driver of the vehicle VH of causing the vehicle VH to unnecessarily enter the zebra zone, the road shoulder, or the like when the operation of the driver of the vehicle VH of causing the vehicle VH to turn right or turn left is needed corresponds to the log of the wrong operation.

For example, the log of the operation of the driver of the vehicle VH of turning on the hazard lamp which is unnecessary for the vehicle VH to turn right or turn left when the operation of the driver of the vehicle VH of causing the vehicle VH to turn right or turn left is needed corresponds to the log of the wrong operation.

For example, the log of the operation of the driver of the vehicle VH of causing the vehicle VH to travel against the laws and regulations (for example, to travel in the opposite direction) when the operation of the driver of the vehicle VH of causing the vehicle VH to turn right or turn left is needed corresponds to the log of the wrong operation.

In the example shown in FIG. 1 to FIG. 4, the simulator SY4 is disposed in the server SV. Specifically, the processor SV3 of the computer constituting the server SV has a function as the simulator SY4. The simulator SY4 simulates behavior of the navigation information generation unit SY1. The second machine learning model SY22 cooperates with the simulator SY4, and repeatedly performs prediction of behavior of the driver of the vehicle VH and optimization of the transmission information generated by the machine learning model unit SY2.

The machine learning model unit SY2 performs addition or update of the transmission information based on the reaction of the driver of the vehicle VH (feedback of the driver of the vehicle VH such as voice, expression, gesture, and the like) to the transmission information communicated from the user interface VH1 to the driver of the vehicle VH.

As described above, in the navigation system SY of the first embodiment, the lightweight large-scale language model SY21A and the large-scale language model SY22A are used, and navigation optimized for communication skills, personality, preconception, and experience of the driver of the vehicle VH is performed. Thus, even with complicated route, complicated road shape, and poor communication situation between the vehicle VH and the server SV, the driver of the vehicle VH can be appropriately navigated.

In one example of the navigation system SY of the first embodiment, when the driver of the vehicle VH inputs the destination for this trip, the large-scale language model SY22A of the server SV uses the personal information of the driver of the vehicle VH (characteristic of the driver of the vehicle VH), the log of a past wrong decision, and the instruction content of the navigation system SY at that time, predicts in what situation of this trip the driver of the vehicle VH is likely to perform the wrong operation, and communication (content output as the voice guidance from the user interface VH1, timing, tone of the voice, kind of the voice, and display content on the display) for preventing the driver of the vehicle VH from performing the wrong operation in advance, and provides the advance instruction to the lightweight large-scale language model SY21A mounted on the vehicle VH. The lightweight large-scale language model SY21A receives real-time navigation information output from the navigation information generation unit SY1, and issues the instruction to the driver of the vehicle VH by the communication means (the voice guidance and the image guidance of the user interface VH1) which is optimum for the driver of the vehicle VH based on the advance instruction from the large-scale language model SY22A of the server SV. The result in the trip is stored in the log and used to aid in a further improvement of navigation in next and subsequent trips.

If all processes are performed by the large-scale language model mounted on the vehicle VH, process performance of the computer VH7 (for example, vehicle-mounted electronic control unit (ECU), and the like) mounted on the vehicle VH becomes a bottleneck and delays occur, and the navigation cannot be performed at appropriate timing. If all processes are performed by the large-scale language model SY22A of the server SV, the navigation cannot be performed at appropriate timing due to the communication delay between the server SV and the vehicle VH.

Thus, in the navigation system SY of the first embodiment, LLM process which requires real-time performance is performed by the lightweight large-scale language model SY21A mounted on the vehicle VH, and LLM process which does not require real-time performance is performed by the large-scale language model SY22A mounted on the server SV.

In another example of the navigation system SY of the first embodiment, the navigation information generation unit SY1 may be provided not only in the vehicle VH but also in the server SV, and the simulator SY4 may perform the simulation of the navigation information generation unit SY1 in the server SV.

In this example, the large-scale language model SY22A mounted on the server SV performs the simulation of the navigation instruction in the trip and the itinerary by cooperating with the simulator SY4 of the navigation information generation unit SY1 in the server SV based on the advance information such as the destination and the like input in advance by the driver of the vehicle VH, performs the simulation of the reaction of the driver of the vehicle VH to the navigation instruction, and creates the advance instruction based on the result of the simulation. This step may be performed by repeating the simulation and the iteration of improvement for a plurality of times.

When the driver of the vehicle VH drives to an unfamiliar destination or when a route to the destination is complicated, the navigation system SY is extremely useful.

For example, in a conventional navigation system as in the technique described in PTL 1, when the road shape is complicated, the instruction issued from the navigation system may not be appropriately conveyed to the driver of the vehicle, and the driver of the vehicle may travel along the wrong route, and the navigation system may make the driver of the vehicle confused and mislead the driver. Furthermore, in the conventional navigation system, the delay of the voice guidance from the navigation system to the driver of the vehicle may occur due to the influence of process load of the central processing unit (CPU) of the navigation system and the communication delay of the GPS and the network, and the driver of the vehicle may get confused.

As described above, in the navigation system SY of the first embodiment, the problem of the conventional navigation system can be solved.

In the navigation system SY of the first embodiment, the warning is issued in the situation which specifically match the situation in which the decision mistake of the driver of the vehicle VH becomes apparent. Also, in the navigation system SY of the first embodiment, a case (log of the operation of the driver of the vehicle VH) such as a case which did not become apparent, and in which cognitive burden and stress of the driver of the vehicle VH increased due to the confusion and the like of the driver of the vehicle VH, but in which potential risk did not become apparent, discomfort of the driver of the vehicle VH did not become apparent, in other words, there were no driving problems finally. In the navigation system SY of the first embodiment, the machine learning model unit SY2 (LLM) performs the process for preventing the wrong operation of the driver of the vehicle VH in consideration of the characteristic of the driver of the vehicle VH.

### First Example

When driving experience and concurrent process capacity of the driver of the vehicle VH are poor, if a plurality of instructions are simultaneously issued from the navigation system SY, the driver of the vehicle VH may get into a panic. Also, when the driver of the vehicle VH performs a certain operation, the driver of the vehicle VH may forget presence of another operation which is different from the certain operation.

In an example, when the navigation system SY issues the instruction of “Left direction after 50 m. Then, right direction after 30 m.”, the driver of the vehicle VH panics and turns right instead of turning left.

In another example, when the navigation system SY issues the instruction of “Left direction after 50 m. Then, right direction after 30 m.”, the driver of the vehicle VH does not know which way to turn after turning left, and temporarily stops the vehicle VH in the zebra zone.

In a first example, logs of those two examples are stored in the log database. Further, the large-scale language model SY22A of the server SV determines that the driver of the vehicle VH panics due to the complicated instruction and the plurality of simultaneously issued instructions. Furthermore, the large-scale language model SY22A of the server SV considers the determination result and issues the advance instruction to the lightweight large-scale language model SY21A of the vehicle VH so that the lightweight large-scale language model SY21A issues sequential process instructions as follows, for example.

The lightweight large-scale language model SY21A of the vehicle VH issues the instruction of “enter left lane”, then issues the instruction of “reduce speed to XX km/h (speed in which there is enough time for the reaction of the driver of the vehicle VH even when the instruction to turn right is issued after turning left)”, then issues the instruction of “maintain speed, and turn left after 50 m”, and then issues the instruction of “turn right after 30 m” based on the advance instruction from the large-scale language model SY22A of the server SV.

As described above, in the example of the navigation system SY of the first embodiment, the machine learning model unit SY2 generates the transmission information so that the confusion in any of the recognition, the decision, and the operation of the driver of the vehicle VH is suppressed based on the transmission information communicated to the driver of the vehicle VH via the user interface VH1 when the determination unit SY3 determines that there has been the confusion in any of the recognition, the decision, and the operation of the driver of the vehicle VH with respect to the transmission information which is the information to be communicated to the driver of the vehicle VH via the user interface VH1, and the reaction of the driver of the vehicle VH to the transmission information.

In a modification example of the first example of the navigation system SY of the first embodiment, the machine learning model unit SY2 causes the navigation information generation unit SY1 to generate the navigation information so that the confusion in any of the recognition, the decision, and the operation of the driver of the vehicle VH is suppressed based on the transmission information communicated to the driver of the vehicle VH via the user interface VH1 when the determination unit SY3 determines that there has been the confusion in any of the recognition, the decision, and the operation of the driver of the vehicle VH with respect to the transmission information, and the reaction of the driver of the vehicle VH to the transmission information.

Specifically, in the modification example of the first example of the navigation system SY of the first embodiment, the machine learning model unit SY2 causes the navigation information generation unit SY1 to generate the navigation information so that the confusion in any of the recognition, the decision, and the operation of the driver of the vehicle VH is suppressed based on the personal information related to any of the recognition, the decision, and the operation of the driver of the vehicle VH, the transmission information, and the reaction of the driver of the vehicle VH to the transmission information.

In other words, in the modification example of the first example of the navigation system SY of the first embodiment, the machine learning model unit SY2 causes the navigation information generation unit SY1 to generate the navigation information so that the navigation system SY performs the route guidance so that the driver of the vehicle VH is not confused about the decision.

### Second Example

For example, in long-distance expressway traveling, attention of the driver of the vehicle VH is likely to become distracted, and the driver of the vehicle VH may miss the transmission information which is the information to be communicated to the driver of the vehicle VH via the user interface VH1.

Thus, in a second example of the navigation system SY of the first embodiment, when attention of the driver of the vehicle VH during long-distance expressway traveling is distracted (for example, when more than 10 minutes have passed since the previous navigation), the instruction to the driver of the vehicle VH is issued by changing the tone, volume, and speaking style of the voice in the voice guidance.

### Third Example

A degree to which the driver of the vehicle VH pays attention to the transmission information communicated to the driver of the vehicle VH via the user interface VH1 varies depending on a case where the voice guidance from the user interface VH1 to the driver of the vehicle VH is the mechanical tone of voice, a case where the voice guidance from the user interface VH1 to the driver of the vehicle VH is the casual tone of voice of the opposite sex, a case where the voice guidance from the user interface VH1 to the driver of the vehicle VH is the casual tone of voice of the same sex, and the like.

Thus, in a third example of the navigation system SY of the first embodiment, an analysis of the tone of voice of the voice guidance having a great degree to which the driver of the vehicle VH pays attention is performed, and optimization of the tone of voice of the voice guidance from the user interface VH1 to the driver of the vehicle VH is performed based on the analysis result (i.e., the degree to which the driver of the vehicle VH pays attention is improved).

### Fourth Example

If the sense of distance of the driver of the vehicle VH is poor, the driver of the vehicle VH may not be able to accurately recognize the position of the vehicle VH after the vehicle VH moves forward 50 m based on, for example, the voice guidance of “50 m forward”.

Thus, in a fourth example of the navigation system SY of the first embodiment, when a fact that the sense of distance of the driver of the vehicle VH is poor is acquired as the personal information of the driver of the vehicle VH or the log of the operation of the driver of the vehicle VH, the voice guidance such as, for example, “there is YY store on right side, turn on the left blinker after 3 seconds after passing the store, and turn left at first intersection” is issued instead of, for example, the voice guidance of “after 50 m”.

### Fifth Example

In a fifth example of the navigation system SY of the first embodiment, when the driver of the vehicle VH shows the vocal reaction of “Hold on. I am not sure at all!”, to the transmission information (guidance) generated by the machine learning model unit SY2 and communicated to the driver of the vehicle VH via the user interface VH1, the voice of the driver of the vehicle VH is collected by the microphone VH4. The driver monitoring system SY33 determines that there has been the confusion in the recognition and the like of the driver of the vehicle VH with respect to the transmission information generated by the machine learning model unit SY2, records the reaction of the driver of the vehicle VH in the log, and feeds the log back to the server SV. The second machine learning model SY22 (large-scale language model SY22A) of the server SV updates the transmission information generated by the machine learning model unit SY2 so that the driver of the vehicle VH does not react in such a manner.

Further, in the fifth example of the navigation system SY of the first embodiment, when the driver of the vehicle VH shows the vocal reaction of “Should I go left here? Or go straight ahead? I am not sure.”, to the transmission information generated by the machine learning model unit SY2 and communicated to the driver of the vehicle VH via the user interface VH1, the voice of the driver of the vehicle VH is collected by the microphone VH4. The driver monitoring system SY33 determines that there has been the confusion in the recognition and the like of the driver of the vehicle VH with respect to the transmission information generated by the machine learning model unit SY2, records the reaction of the driver of the vehicle VH in the log, and feeds the log back to the server SV. The second machine learning model SY22 of the server SV updates the transmission information generated by the machine learning model unit SY2 so that the driver of the vehicle VH does not react in such a manner.

Furthermore, in the fifth example of the navigation system SY of the first embodiment, when the driver of the vehicle VH shows the reaction of opening his/her eyes wide, making an irritated expression, gesture or the like to the transmission information (guidance) generated by the machine learning model unit SY2 and communicated to the driver of the vehicle VH via the user interface VH1, the reaction of the driver of the vehicle VH is captured by the driver monitor camera VH3. The driver monitoring system SY33 determines that there has been the confusion in the recognition and the like of the driver of the vehicle VH with respect to the transmission information generated by the machine learning model unit SY2, records the reaction of the driver of the vehicle VH in the log, and feeds the log back to the server SV. The second machine learning model SY22 of the server SV updates the transmission information generated by the machine learning model unit SY2 so that the driver of the vehicle VH does not react in such a manner.

### Sixth Example

In a sixth example of the navigation system SY of the first embodiment, when the driver of the vehicle VH shows the vocal reaction of “Hold on. I am not sure at all!”, “Should I go left here? Or go straight ahead?I am not sure.”, and the like, to the transmission information (guidance) generated by the machine learning model unit SY2 and communicated to the driver of the vehicle VH via the user interface VH1, the driver monitoring system SY33 determines that there has been the confusion in the recognition and the like of the driver of the vehicle VH with respect to the transmission information generated by the machine learning model unit SY2, and the first machine learning model SY21 (lightweight large-scale language model SY21A) mounted on the vehicle VH responsively issues the additional instruction, or generates and outputs the instruction which is more specific than the transmission information (instruction) communicated to the driver of the vehicle VH.

As described above, in the navigation system SY of the first embodiment, the confusion in any of the recognition, the decision, and the operation of the driver of the vehicle VH can be suppressed as much as possible.

### Second Embodiment

The navigation system SY of a second embodiment is configured similarly to the navigation system SY of the first embodiment described above except for points described below.

As described above, in the example (example shown in FIG. 1 to FIG. 4) of the navigation system SY of the first embodiment, the navigation system SY is configured by the computer VH7 mounted on the vehicle VH and the computer of the server SV.

On the other hand, the navigation system SY of the second embodiment is configured by the computer VH7 mounted on the vehicle VH. Specifically, in one example of the navigation system SY of the second embodiment, the processor VH73 of the computer VH7 mounted on the vehicle VH has the function as the simulator SY4. In the example of the navigation system SY of the second embodiment, the machine learning model corresponding to the second machine learning model SY22 (see FIG. 2) is stored in the storage device VH72 of the computer VH7 of the vehicle VH. The machine learning model corresponding to the second machine learning model SY22 (see FIG. 2) in the navigation system SY of the second embodiment includes the large-scale language model corresponding to the large-scale language model SY22A (see FIG. 2).

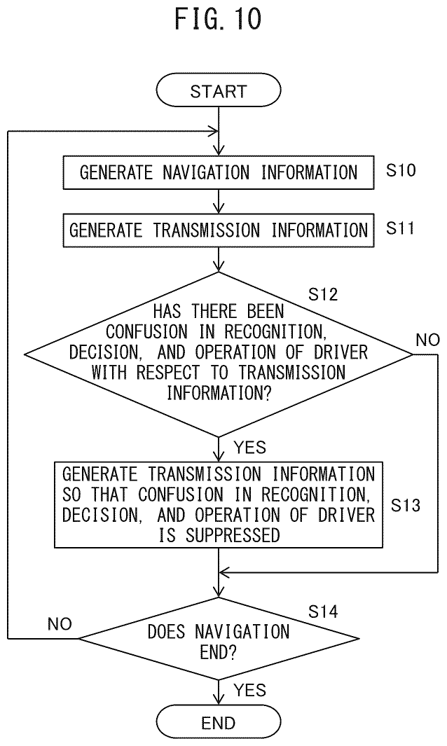

FIG. 10 is a flowchart for explaining one example of process performed by the processor VH73 of the computer VH7 mounted on the vehicle VH to which the navigation system SY of the second embodiment is applied.

In the example shown in FIG. 10, at step S10, the navigation information generation unit SY1 generates the navigation information based on the current position of the vehicle VH, the map information, and the destination information indicating the destination of the vehicle VH.

At step S11, the machine learning model unit SY2 generates the transmission information which is the information to be communicated to the driver of the vehicle VH via the user interface VH1 based on the navigation information generated at step S10.

At step S12, the determination unit SY3 determines whether there has been the confusion in any of the recognition, the decision, and the operation of the driver of the vehicle VH with respect to the transmission information communicated from the user interface VH1 to the driver of the vehicle VH based on the reaction of the driver of the vehicle VH to the transmission information. When YES, the process proceeds to step S13, and, when NO, the process proceeds to step S14.

At step S13, the machine learning model unit SY2 generates the transmission information so that the confusion in any of the recognition, the decision, and the operation of the driver of the vehicle VH is suppressed based on the transmission information communicated to the driver of the vehicle VH via the user interface VH1 when it is determined that there has been the confusion in any of the recognition, the decision, and the operation of the driver of the vehicle VH with respect to the transmission information at step S12 and the reaction of the driver of the vehicle VH to the transmission information.

At step S14, for example, the determination unit SY3 determines whether the navigation ends. When YES, the process shown in FIG. 10 ends, and, when NO, the process returns to step S10.

### Third Embodiment

The navigation system SY of a third embodiment is configured similarly to the navigation system SY of the first embodiment described above except for points described below.

As described above, in the example (example shown in FIG. 1 to FIG. 4) of the navigation system SY of the first embodiment, the second machine learning model SY22 of the server SV generates the advance instruction to the first machine learning model SY21 based on the destination information and the personal information of the driver of the vehicle VH, and the first machine learning model SY21 of the vehicle VH generates the transmission information which is the information to be communicated to the driver of the vehicle VH in real time based on the advance instruction generated by the second machine learning model SY22 and the navigation information generated by the navigation information generation unit SY1. In other words, in the navigation system SY of the first embodiment, the communication delay between the server SV and the vehicle VH is taken into consideration.

Meanwhile, communication time between the server SV and the vehicle VH can be expected to be shortened by development of communication techniques. Thus, in one example of the navigation system SY of the third embodiment, the machine learning model unit SY2 is configured by only the second machine learning model SY22 of the server SV. Specifically, in the example of the navigation system SY of the third embodiment, the second machine learning model SY22 of the server SV generates the transmission information which is the information to be communicated to the driver of the vehicle VH in real time based on the navigation information generated by the navigation information generation unit SY1.

As described above, the embodiments of the navigation system, the navigation method, and the non-transitory recording medium of the present disclosure are described with reference to the drawings, but the navigation system, the navigation method, and the non-transitory recording medium of the present disclosure are not limited to the embodiments described above, and may be appropriately modified without departing from the scope of the present disclosure. The configuration of each example of the embodiments described above may be appropriately combined. In each example of the embodiments described above, the process performed in the navigation system SY is described as software process performed by executing the program, but the process performed in the navigation system SY may be process performed by hardware. Alternatively, the process performed in the navigation system SY may be a combination of both software and hardware. The program (program for realizing the function of the processor VH73 of the computer VH7 of the vehicle VH of the navigation system SY) stored in the storage device VH72 of the computer VH7 of the vehicle VH of the navigation system SY may be recorded in a computer-readable storage medium (non-transitory recording medium) such as, for example, semiconductor memory, magnetic recording medium, optical recording medium, of the like for providing, distribution or the like.

1. A navigation system comprising a processor configured to:
generate navigation information used for providing navigation to a driver of a vehicle based on current position of the vehicle, map information, and destination information indicating a destination of the vehicle;
generate transmission information which is information to be communicated to the driver via a user interface based on the navigation information; and
determine whether there has been confusion in any of recognition, decision, and operation of the driver with respect to the transmission information communicated from the user interface to the driver based on reaction of the driver to the transmission information,
wherein the transmission information is generated or the navigation information is generated so that the confusion in any of the recognition, the decision, and the operation of the driver is suppressed based on the transmission information communicated to the driver via the user interface and the reaction of the driver to the transmission information when it is determined that there has been the confusion in any of the recognition, the decision, and the operation of the driver with respect to the transmission information.

2. The navigation system according to claim 1, wherein
a first machine learning model stored in a storage device of the vehicle and a second machine learning model stored in a storage device of a server are included in the navigation system,
the second machine learning model generates an advance instruction to the first machine learning model based on the destination information, and
the first machine learning model generates the transmission information in real time based on the advance instruction generated by the second machine learning model and the navigation information.

3. The navigation system according to claim 1, wherein the processor is configured to generate the transmission information or generate the navigation information so that the confusion in any of the recognition, the decision, and the operation of the driver is suppressed based on personal information related to any of the recognition, the decision, and the operation of the driver, the transmission information, and the reaction of the driver to the transmission information.

4. The navigation system according to claim 2, further comprising a simulator disposed in the server, wherein
the simulator simulates behavior to generate the navigation information, and
the second machine learning model cooperates with the simulator, and repeatedly performs prediction of behavior of the driver and optimization of the transmission information.

5. The navigation system according to claim 1, wherein the transmission information is communicated from the user interface to the driver as voice guidance output from a speaker or image guidance displayed on a display.

6. The navigation system according to claim 1, wherein determination of whether there has been the confusion in any of the recognition, the decision, and the operation of the driver with respect to the transmission information is performed by a recognizer which detects information of a compartment line included in an image captured by a front camera mounted on the vehicle.

7. The navigation system according to claim 1, wherein determination of whether there has been the confusion in any of the recognition, the decision, and the operation of the driver with respect to the transmission information is performed by the processor which controls braking actuator or steering actuator based on the operation of the driver.

8. The navigation system according to claim 1, wherein determination of whether there has been the confusion in any of the recognition, the decision, and the operation of the driver with respect to the transmission information is performed by a driver monitoring system for identifying the reaction of the driver to the transmission information based on image of the driver captured by a driver monitor camera or voice of the driver collected by a microphone.

9. The navigation system according to claim 5, wherein the transmission information generated by the processor includes information of any of timing, order, granularity and concreteness of guidance, additional information provided during guidance, type, tone, volume and speaking style of voice, display content, display position, display size, color and font of the image guidance.

10. The navigation system according to claim 1, wherein the processor is configured to perform addition or update of the transmission information based on the reaction of the driver to the transmission information communicated from the user interface to the driver.

11. A navigation method comprising:
generating navigation information used for providing navigation to a driver of a vehicle based on current position of the vehicle, map information, and destination information indicating a destination of the vehicle;
generating transmission information which is information to be communicated to the driver via a user interface based on the navigation information; and
determining whether there has been confusion in any of recognition, decision, and operation of the driver with respect to the transmission information communicated from the user interface to the driver based on reaction of the driver to the transmission information,
wherein the transmission information is generated or the navigation information is generated so that the confusion in any of the recognition, the decision, and the operation of the driver is suppressed based on the transmission information communicated to the driver via the user interface and the reaction of the driver to the transmission information when it is determined that there has been the confusion in any of the recognition, the decision, and the operation of the driver with respect to the transmission information.

12. A non-transitory recording medium having recorded thereon a computer program for causing a processor included in a computer mounted on a vehicle to perform a process comprising:
generating navigation information used for providing navigation to a driver of a vehicle based on current position of the vehicle, map information, and destination information indicating a destination of the vehicle;
generating transmission information which is information to be communicated to the driver via a user interface based on the navigation information; and
determining whether there has been confusion in any of recognition, decision, and operation of the driver with respect to the transmission information communicated from the user interface to the driver based on reaction of the driver to the transmission information,
wherein the transmission information is generated or the navigation information is generated so that the confusion in any of the recognition, the decision, and the operation of the driver is suppressed based on the transmission information communicated to the driver via the user interface and the reaction of the driver to the transmission information when it is determined that there has been the confusion in any of the recognition, the decision, and the operation of the driver with respect to the transmission information.
